(19) United States
(12) Patent Application Publication
(10) Pub. No.: US 2012/0185332 A1
(43) Pub. Date: Jul. 19, 2012

(54) Serving Advertisements Based on Article Availability

(75) Inventor: Eldon S. Larsen, McMurray, PA (US)

(73) Assignee: Google Inc., Mountain View, CA (US)

(21) Appl. No.: 13/007,120

(22) Filed: Jan. 14, 2011

(51) Int. Cl. G06Q 30/00

(52) U.S. Cl. 705/14.54

(57) ABSTRACT

A computer-implemented method for serving advertisements based on article availability includes: receiving a first keyword submitted by a user for performing a search among articles offered by a merchant; determining, using information associated with the merchant, whether the merchant offers a first article for sale that corresponds to the first keyword; and forwarding at least one advertisement in response to the first keyword, the advertisement selected without using the first keyword if the merchant offers the first article, and selected using at least the first keyword otherwise.

### TECHNICAL FIELD

This document relates to serving advertisements based on article availability.

### BACKGROUND

The Internet provides access to a wide variety of resources. For example, online stores, video and/or audio content, as well as web pages for news or other subjects are accessible over the Internet. These resources present opportunities for presenting advertisements. For example, a web page can be designed to include one or more ad slots in which ads can be presented. These ads slots can be defined as part of the web page or defined for presentation with a web page, for example, in a pop-up window.

Merchants offer a variety of articles for sale on the Internet. For example, a merchant may have one or more web pages or web sites that a consumer can access to view and purchase the articles that the merchant offers. A merchant's web site may also include ads for the merchant's articles, or articles for sale by other merchants, or both.

### SUMMARY

In a first aspect, a computer-implemented method for serving advertisements based on article availability includes: receiving a first keyword submitted by a user for performing a search among articles offered by a merchant; determining, using information associated with the merchant, whether the merchant offers a first article for sale that corresponds to the first keyword; and forwarding at least one advertisement in response to the first keyword, the advertisement selected without using the first keyword if the merchant offers the first article, and selected using at least the first keyword otherwise.

In a second aspect, a computer program product is tangibly embodied in a computer-readable storage medium and includes instructions that when executed by a processor perform a method for serving advertisements based on article availability. The method includes: receiving a first keyword submitted by a user for performing a search among articles offered by a merchant; determining, using information associated with the merchant, whether the merchant offers a first article for sale that corresponds to the first keyword; and forwarding at least one advertisement in response to the first keyword, the advertisement selected without using the first keyword if the merchant offers the first article, and selected using at least the first keyword otherwise.

In a third aspect, a system includes: a processor; and a computer-readable storage medium having stored therein instructions that when executed by the processor perform a method. The method includes: receiving a first keyword submitted by a user for performing a search among articles offered by a merchant; determining, using information associated with the merchant, whether the merchant offers a first article for sale that corresponds to the first keyword; and forwarding at least one advertisement in response to the first keyword, the advertisement selected without using the first keyword if the merchant offers the first article, and selected using at least the first keyword otherwise.

Implementations can include any or all of the following features. The information is at least in part based on advertisement data regarding earlier advertisement servings for the merchant. The information includes a poor-performer keywords list and a good-performer keywords list, wherein the first keyword is used in selecting the advertisement if the first keyword does not appear on the poor-performer keywords list, and wherein if the first keyword does appear on the poor-performer keywords list, the advertisement is instead selected using at least one second keyword from the good-performer keywords list associated with the first keyword. Respective annotations are assigned to the keywords on the poor-performer and good-performer keywords lists; and associations between the poor-performer and good-performer keywords lists are generated by matching the respective annotations to each other. The information is at least in part provided by the merchant. The information is generated with regard to a merchant category; and the information is associated with the merchant based on the merchant category. Broadening terms are identified for the first keyword; and a selection is made which of the broadening terms to use in selecting the advertisement, the selection based on whether the merchant offers the first article for sale.

Particular implementations may realize one or more of the following advantages. By serving an ad for a sought article that is currently not offered by a merchant, the served ad addresses the user's expressed interest and does not detract the customer's attention from the merchant's articles. On the other hand, when the merchant currently has the sought article available, an ad for another article is served, so as to not detract the customer's attention from the merchant's offering of the sought article.

The details of one or more implementations are set forth in the accompanying drawings and the description below. Other features and advantages will be apparent from the description and drawings, and from the claims.

### DESCRIPTION OF DRAWINGS

FIG. 1 is a block diagram of an example system for serving ads based on article availability.

FIG. 2 is a block diagram of an example ad targeting module that forwards ads based on article availability from a merchant for a particular keyword.

FIG. 3A is a screenshot of an example user interface that includes an ad selected without regard to a user-entered keyword.

FIG. 3B is a screenshot of an example user interface that includes an ad selected with regard to the user-entered keyword.

FIG. 4 is a flow diagram of an example process for serving ads based on article availability.

FIG. 5 is a block diagram of a computing system that can be used in connection with computer-implemented methods described in this document.

Like reference symbols in the various drawings indicate like elements.

### DETAILED DESCRIPTION

This document describes service of a targeted ad based on availability of an article (e.g., product or service) sought by a user. The user enters an online query on a merchant's page for products or services that the user wishes to buy. Generally, if the user enters a keyword that is sufficiently specific as to the article name, the sought article is either available from the merchant or not. When the sought article is not currently available from the merchant, the system can serve an ad for the sought product from another merchant. On the other hand, when the keyword identifies an article that is available, then the system can serve an ad for another product or service, instead of serving an ad corresponding to the sought article. For example, in such situation the ad that is served can be for an accessory that is related to the merchant's article.

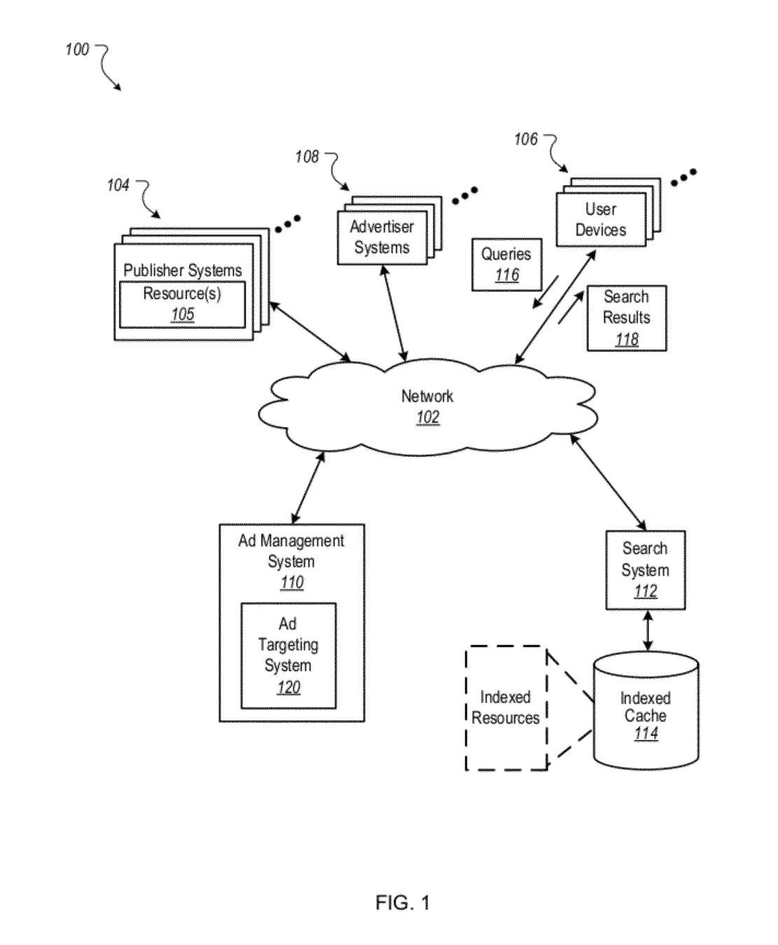

FIG. 1 is a block diagram of an example system 100 for serving ads based on article availability. The system 100 includes at least one network 102, such as a local area network (LAN), a wide area network (WAN), the Internet, or a combination thereof. The network 102 connects any or all of publisher systems 104, user devices 106, advertiser systems 108, and ad management system 110. The system 100 may include any number of publisher systems 104, user devices 106, advertiser systems 108 and management systems 110.

In some implementations, the merchant offers articles to potential customers on a resource 105, for example one or more websites. An example website is a collection of web pages formatted in hypertext markup language (HTML) that can contain text, images, multimedia content, and/or programming elements, such as scripts. Each publisher system 104 can be maintained by a publisher, which is an entity that controls, manages and/or owns the publisher system 104.

Each publisher system 104 includes one or more of the resources 105 hosted by one or more servers. The resource 105 can include any type of data that can be provided over the network 102. The resource 105 can be identified by a resource address, e.g., a uniform resource locator (URL) or a uniform resource identifier (URI), associated with the resource 105. Resources include HTML pages, word processing documents, portable document format (PDF) documents, images, video, and news feed sources, to name only a few examples. The resources can include content, such as words, phrases, images and sounds, that may include embedded information (such as meta-information in hyperlinks) and/or embedded instructions (such as JavaScript).

For example, the resource 105 can be referred to as a merchant page. The merchant page can be a web page that includes content, such as content related to the articles (e.g., products and/or services) that the merchant offers for sale. The merchant page can include advertising slots in which one or more ads can be placed. The ads that appear on a merchant page can be ads from other merchants. Such other merchants whose ads are candidates for being served on the merchant's page can include associated merchants, competing merchants, and/or unrelated merchants, to name just a few examples. One advantage of the system 100 can be that, when ads are served on a merchant page, the advertised articles do not unduly draw the user's attention away from the articles that the merchant offers for sale.

A user device 106 is an electronic device that is under control of at least one user and is configured for use in requesting and receiving one or more types of resources over the network 102. Example user devices 106 include personal computers, mobile communication devices (e.g., smartphones), and/or any other devices that can send and receive data over the network 102. A user device 106 can be provided with one or more applications for performing functions. For example, a web browser is provided to facilitate the sending and receiving of data over the network 102.

A user device 106 can request one or more of the resources 105 from a publisher system 104. In response to the request, data corresponding to the resource 105 is provided to the user device 106 for presentation by the user device 106. For example, the resource 105 represents an online store or other commercial establishment. The data representing the resource 105 can also include data specifying that ads can be displayed in a portion of the resource, or in a portion of a user display (e.g., a presentation location of a pop-up window or in a slot of a web page). The specified portions of the resource or user display can be referred to as ad slots.

The system 100 can include one or more search systems 112 that facilitate searching among the resources provided by the publishers on the publisher systems 104. In some implementations, the search system 112 is implemented by one or more publishers for use by its customers. For example, the merchant can implement a search function on one or more web pages, using the search system 112, for searching among the merchant's articles.

In some implementations, the resources 105 are indexed and the search system 112 makes the index available for searching. Data about the resources can be indexed based on the resource to which the data corresponds. The indexed and, optionally, cached copies of the resources can be stored in an indexed cache 114.

User devices 106 can submit search queries 116 to the search system 112 using the network 102. In response, the search system 112 can access the indexed cache 114 to identify any of the resources that are relevant to the search query 116. The search system 112 identifies zero or more of the resources in the form of search results 118 and returns the search results 118 to the user devices 106 for presentation in one or more search results pages. A search result 118 is data generated by the search system 112 that can identify one or more resources as responsive to a particular search query, and can include link(s) to any such resource(s). In some implementations, the search result 118 is included in one or more pages of the resource 105 when displayed. For example, a first page from the resource 105 provides a search function (and optionally one or more served ads), and a second page generated in response to the search includes the search result 118 and one or more ads chosen based on article availability.

When the resource 105 is requested by the user device 106, an ad request can also be forwarded to the ad management system 110, seeking one or more ads to be provided with the resource 105. In some implementations, the ad request indicates whether the sought product(s) can currently be obtained from the merchant. In other implementations, the ad management system 110 can already have been provided with information that reflects or indicates article availability for one or more merchants.

The ad request can specify characteristics of the one or more ad slots on the requested resource page. For example, a reference (e.g., URL) to the resource for which the ad slot is defined, a size of the ad slot, and/or media types that are available for presentation in the ad slot can be included in the ad request. Similarly, keywords associated with a requested resource (“resource keywords”) or a search query 116 for which search results are requested can also be provided to the ad management system 110 to facilitate identification of ads that are relevant to the resource or search query 116.

Based at least in part on data included in the ad request, the ad management system 110 can select one or more ads as eligible to be provided in response to the request. When the merchant has the sought article(s) available, one or more ads for other articles can be selected and served. In contrast, when the sought article or articles are not available from the merchant, one or more ads for the sought article can be selected. In some implementations, ads having targeting keywords that match the resource keywords or the search query 116 are selected as eligible ads by the ad management system 110.

A resource keyword or the search query 116 can be matched to a targeting keyword that has the same textual content in whole or in part as the resource keyword or search query 116. For example, an ad associated with the targeting keyword “camera” can be eligible for an ad request including the resource keyword “cameras.”

Accordingly, the ad management system 110 can select and serve one or more eligible ads for presentation in ad slots of a resource page. For example, a selected ad can be displayed on the merchant page to the user.

The system 100 includes an ad targeting system 120 that can select one or more ads for a merchant page based on article availability. For example, assume that the user enters a search query for “diamonds”. If the merchant carries diamonds and lists them (and optionally other articles) for sale, then the ad targeting system 120 can select and serve ads for products other than diamonds on the merchant's web site. In contrast, if the merchant does not have diamonds for sale, the ad targeting system 120 can serve one or more ads for a diamond-dealing merchant.

In some implementations, some or all of the functionality of the ad targeting system 120 can be included, for example, in either or both of the ad management system 110 and the user's browser.

After an ad is presented, one or more events relating to the ad can be detected. In some implementations, one or more conversions can be detected. A conversion can be said to occur when a user performs a particular action related to a served ad. What action(s) should count in this regard may vary from case-to-case and can be defined or determined in any of a variety of ways. For example, a conversion may occur when the following criteria are met: A user clicks on an ad, is referred to a web page, and consummates a purchase there before leaving that web page. As another example, a conversion can be defined as any measurable/observable user action, such as a click or mouse-over event; downloading a white paper; navigating to at least a given depth of a website; viewing at least a certain number of web pages; spending at least a predetermined amount of time on a website or web page; or completing a registration process on a website. Other actions can be tracked and used in determining whether a conversion has occurred.

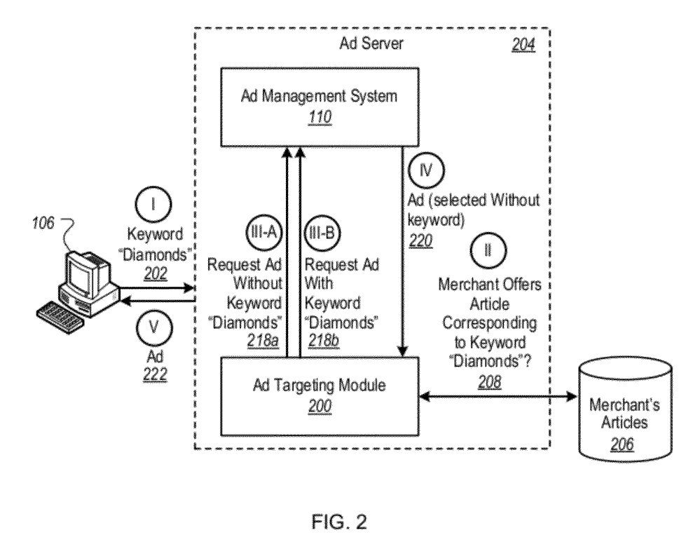

FIG. 2 is a block diagram of an ad targeting module 200 that forwards ads based on article availability for one or more particular keywords. For example, the ad targeting module 200 can be part of the ad targeting system 120 described above with reference to FIG. 1. Using numbered steps I-V, FIG. 2 illustrates an example high-level sequence of events that involves serving an ad in response to a particular search term that is provided by a user.

For example, as a first step (I), a user can enter a search query in a browser on a client device 106. Here, the search query includes a keyword “diamonds” 202. The keyword “diamonds” 202 is received by an ad server 204, which can include the ad targeting system 120 and/or the ad management system 110. In this example, the ad management system 110 and ad targeting module 200 are shown as separate entities to illustrate an example sequence of events.

Next (II), the ad targeting module 200 can access a data store 206 that reflects or indicates the merchant's articles. The ad targeting module 200 can make a determination 208 of whether the merchant offers the article that corresponds to the keyword. Other exemplary direct or indirect determinations of article availability, such as based on tracking past ad success rates, are described below.

Next (III-A and III-B), the ad targeting module 200 can trigger the ad management system 110 to select one or more ads based on the availability. For example, if the determination 208 indicates that the sought article is available, then the ad targeting module 200 can provide (III-A) an ad request 218a that does not use the keyword “diamonds.” Otherwise, if the determination 208 indicates that the sought article is not available, then the ad targeting module 200 can provide (III-A) an ad request 218b that uses at least the keyword “diamonds.”

Next (IV), the ad management system 110 can provide at least one ad 220 responsive to the one of the ad requests 218a or 218b received from the ad targeting module 200. For example, if the merchant is a diamond dealer, the ad 220 can therefore be selected without use of the keyword “diamonds.”

Next (V), the ad server 204 can forward the ad 220 to the user device. For example, the ad 220 can be displayed in the user's browser, such as on or in connection with the merchant page.

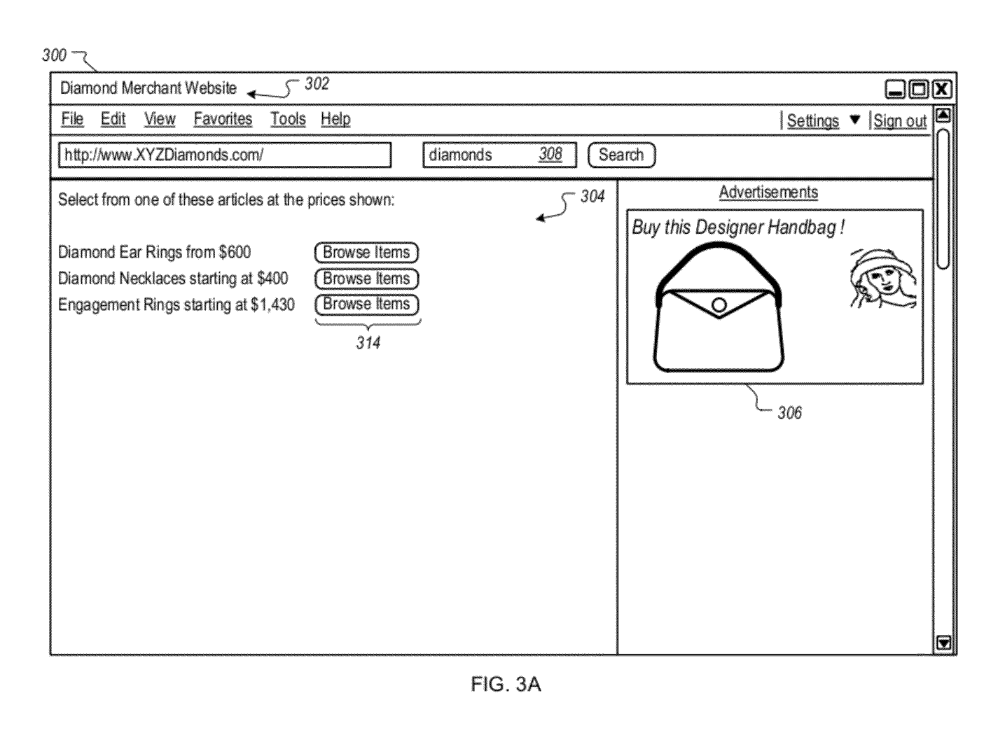

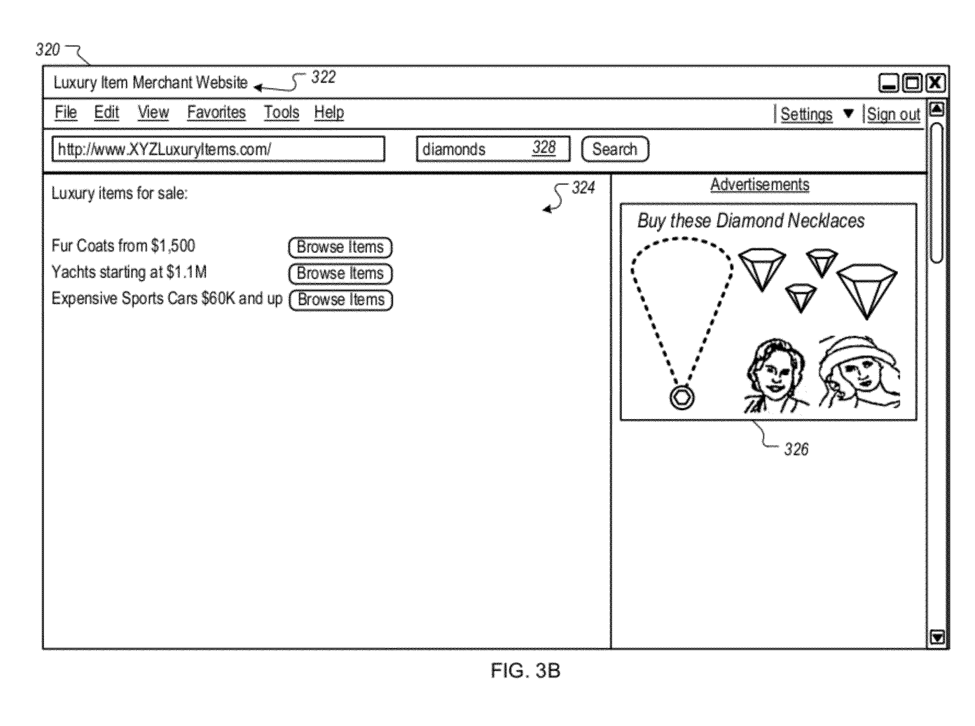

The following examples illustrate availability-based ad serving from a user's perspective. FIG. 3A is a screenshot of an example user interface 300 that includes an ad selected without regard to a user-entered keyword. For example, the user interface 300 can display a web page for a merchant who sells diamonds and diamond-related items, as indicated by a web site title 302.

An articles display area 304 lists example articles (e.g., diamond ear rings, diamond necklaces and engagement rings) that the diamond merchant sells. An ad 306 advertises designer handbags, which in this case is a type of article that the merchant does not sell. For example, the ad 306 can be displayed in response to one or more keywords (e.g., “diamonds” or “blue diamonds”) that are entered in a keyword field 308. The merchant in this example sells diamonds and diamond-related products, and serving a diamond-related ad from a competing merchant could draw the user's attention away from the merchant's offered articles. Therefore, instead of serving an ad related to diamonds, the ad served can be for another type of article that at least partly overlaps with diamonds in consumer interest. For example, the keyword “handbags” can be used. As a result, a non-diamond ad is here selected and served, for example the ad 306 for designer handbags. For the articles that the merchant does offer, the merchant page can include controls 314 for browsing or purchasing items that are summarized in the articles display area 304.

FIG. 3B is a screenshot of an example user interface 320 that includes an ad selected with regard to the user-entered keyword. For example, the user interface 320 can display a web page for a merchant who sells luxury items, as indicated by a web site title 322. In this example, the luxury items offered by the merchant do not include diamonds.

An articles display area 324 lists example articles (e.g., fur coats, yachts and expensive sports cars) that the merchant sells. An ad 326 advertises diamond necklaces, which in this case are not among the articles that the merchant sells. The ad 326 can be displayed in response to one or more keywords (e.g., “diamonds”) that are entered in a keyword field 328. That is, the ad targeting system 120 here selects the ad 326 based on the keyword “diamonds”, for example the ad 326 for diamond necklaces.

The decision by the ad targeting system 120, for example, whether to serve the ad 306 or 326 can be determined using information associated with the merchant. In some implementations, the merchant can provide some of the information, such as in the form of an inventory or list of articles that the merchant sells. The list of articles can be provided to the ad management system 110 and made accessible to the ad targeting system 120. When an ad is to be served, e.g., on the merchant page, a determination can be made whether the merchant offers an article for sale that corresponds to the keyword on which selecting the ad to be served is based. The ad targeting system 120 can select an ad such that the ad that is subsequently served is for an article that does not unduly draw the user's attention away from the merchant's offered articles.

Targeting ads based on article availability by a merchant can either include or exclude articles that are used as keywords to identify ads to be served. For example, if a merchant offers an article that is also the keyword used to identify an ad, then the ad targeting system 120 can identify an ad for a different article instead. The decision to request and serve a different ad can be based on the merchant's inventory of articles and other information for the merchant. In some implementations, the other information for a merchant can include ad data regarding earlier ad servings for the merchant. In some implementations, the ad data can include impressions, clicks and conversions for ads served in response to particular keywords and queries.

For example, the ad management system 110 can track, over time and for each merchant, any queries that users have entered on the merchant page. The ad management system 110 can also track any queries that landed a user on the merchant page and/or resulted in an ad impression, resulted in any clicks by the user, or resulted in a conversion (e.g., the sale of one or more of the merchant's articles). Using ad data regarding earlier ad servings for the merchant, for example, the ad targeting system 120 can avoid serving ads for articles that unduly draw the user's attention away from the merchant's articles. For example, the ad targeting system 120 can target ads by making ad selections that exclude keywords for articles offered by the merchant and include keywords for other articles.

In some implementations, keywords can be classified in one or more categories or groupings, and information available for a merchant can include poor-performer keyword lists and good-performer keyword lists for that merchant. The ability to select one or more other keywords for use in targeting ads can be facilitated by matching poor-performer keyword lists and good-performer keyword lists. By way of definition, poor-performer keyword can include any keyword, as determined by the ad targeting system 120, for example, that led to few (if any) ad impressions, user clicks on ads, and subsequent conversions. By comparison, good-performer keywords can include any keywords that led to a comparatively larger number of impressions, clicks and subsequent conversions. In some implementations, the designation of poor-performer and good-performer keywords can be based on thresholds, e.g., maximum numbers of impressions, clicks and conversions for bad-performer keywords, and minimum numbers of impressions, clicks and conversions for good-performer keywords. For example, some of the information about past queries can be obtained from logs or histories that are generated and/or maintained by the search system 110. In some implementations, the information can be correlated using timestamps or other common elements of the data, including user identifiers, advertisers, and so on. In some implementations, weights or scores can be assigned to events, such that conversions, for example, are considered a more important measure of a good-performer keyword than impressions and/or clicks.

In some implementations, the ad targeting system 120 can request ads in different ways, depending on whether a keyword (e.g., any of the keywords 202, 308 or 328) appears on a poor-performer keywords list. For example, if the keyword does not appear on the poor-performer keywords list, then the ad targeting system 120 can use the keyword in selecting the ad. Otherwise, if the keyword does appear on the poor-performer keywords list, then the ad targeting system 120 can instead select the ad using at least one other keyword from a good-performer keywords list that is associated with the keyword. In this example, the ad targeting system 120 can inject the other keyword into a request for an ad (e.g., the ad request 218a) in order to identify an ad for an article that the merchant does not sell.

Relationships can exist between good-performer keyword lists and poor-performer keyword lists, such as on a merchant category basis. For example, the ad targeting system 120 can assign respective annotations to the keywords on the poor-performer and good-performer keywords lists. The annotations, for example, can be based on clustering keywords for ads that are served by similar merchants, or by clustering keywords for ads served to similar types of users, to name a few examples. Using the annotations, the ad targeting system 120 can generate associations between the poor-performer and good-performer keywords lists by matching the respective annotations to each other. As a result, “expensive designer handbags” can be on a good-performer keywords list that is associated with keywords corresponding to luxury items (e.g., including diamonds). The ad targeting system 120 can use this association, for example, to request the designer handbag ad 306 for a slot on a diamond-dealer merchant page. In this example, the ad targeting system 120 can identify one or more broadening terms (e.g., expensive designer handbags) for the keyword (e.g., diamonds) and, if the merchant offers the first article for sale (e.g., articles related to diamonds), then the ad targeting system 120 can use the broadening terms in requesting and selecting the ad.

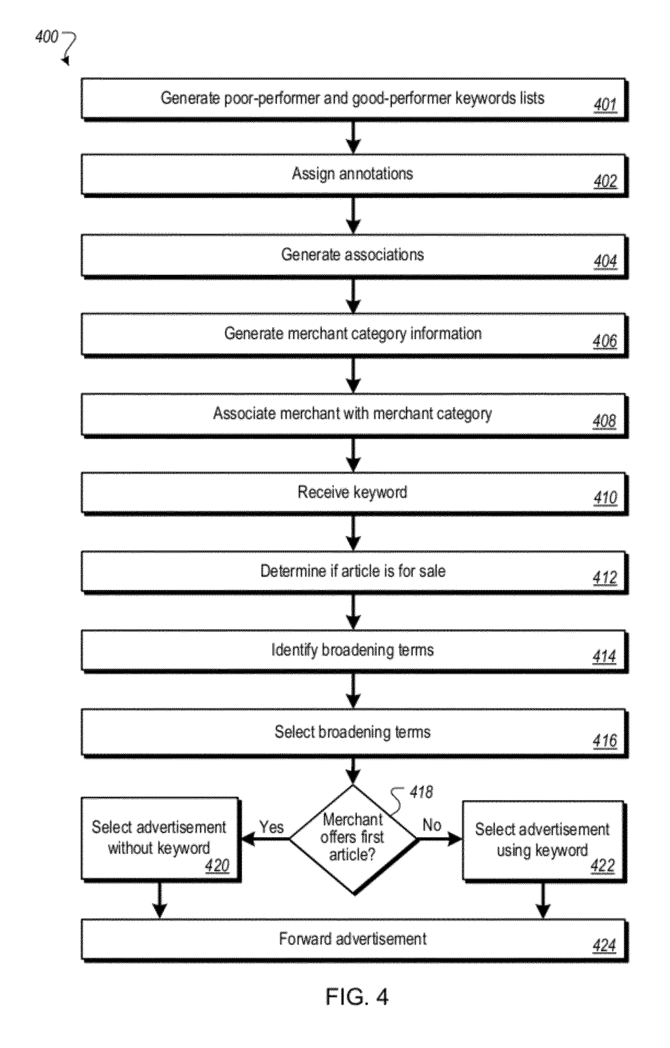

FIG. 4 is a flow diagram of an example process 400 for serving ads based on article availability. For example, referring to in FIG. 1, the system 100, such as the ad targeting system 120, can perform the steps of the process 400. The process 400 can be used, for example, to target ads to users of client devices 106. The ads targeted can be ads (e.g., for advertiser systems 108) that appear on resources 105 (e.g., merchant web sites). The ad targeting system 120 can request ads from the ad management system 110 based on article availability.

Processing can begin in step 401 when good-performer and bad-performer keywords lists are generated. The ad targeting system 120, for example, can analyze or process the information from previously-served ads to identify poor-performer and good-performer keywords. Step 401 can be the first of several steps in the process 400 that are preparatory, in that step 401 and successive steps lay the groundwork for serving ads in subsequent steps.

In step 402, respective annotations are assigned to the keywords on the poor-performer and good-performer keywords lists. For example, the ad targeting system 120 can annotate the queries with additional information. In some implementations, the annotation can include categorizations and classifications of the queries. As an example, annotations for an “iPods” query can include “music, electronics, portable devices,” etc. The annotations can categorize the queries in the same category if, for example, the queries (or keywords on which they are based) correspond to similar articles.

In step 404, associations between the poor-performer and good-performer keywords lists are generated by matching the respective annotations to each other. For example, using the annotations that are assigned in step 402, the ad targeting system 120 can match each poor-performer keyword with one or more good-performer keywords. In some implementations, the process of matching keywords can use a similarity function that takes into account the annotations. For example, if the “iPods” query is a poor-performer keyword, then the ad targeting system 120 can select a “cameras” keyword from the list of good-performer keywords because “iPods” and “cameras” are both electronic and portable devices.

In step 406, information with regard to a merchant category is generated. For example, merchant categories can include a category of electronics merchants, a category of diamond merchants, and so on. In this example, the merchant categories are based on articles (e.g., products or services) that the merchants sell. Other types of categories can exist, such as categories of merchants who sell “green” or environmentally conscious products, categories of merchants who are not-for-profit, categories of merchants who operate in certain geographic areas, categories of merchants who cater to one or more specific demographics (e.g., age, gender, income), and so on.

In some implementations, the ad targeting system 120 can generate the merchant categories using merchant information that is available from the ad management system 110. The information can include, for example, the articles that each merchant offers for sale. In some implementations, resulting merchant categories may each include a single merchant, e.g., if the merchant is unique in some way, such as a significant advertising “partner.” In some implementations, several merchants can belong to a merchant category if the merchants share certain characteristics (e.g., in addition to the articles they sell), such as a group of related advertising “partners.”

In some implementations, article cost can be a factor in determining merchant categories. For example, separate categories can exist for merchants who sell high-end electronics and merchants who sell low-end electronics. As a result, while merchants in both groups may belong to an all-inclusive electronics category, merchants in either group can belong to different additional merchant categories based on article cost.

A merchant can belong to more than one category, for example, if the merchant sells a wide range of articles. For example, an online merchant who sells cameras and diamonds necklaces can belong to merchant categories that are associated with both types of articles. In some cases, a merchant can belong to a single merchant category, for example, if the merchant sells a very narrow line of articles or a single article. As a result, if a merchant is the only supplier or dealer of a particular article, then the merchant can be in a merchant category that includes one merchant.

In some implementations, the ad targeting system 120 can map good-performer keywords and poor-performer keywords on a merchant category basis. For example, to the category of merchants who sell electronics, the ad targeting system 120 can map good-performer keywords that lead to a relatively higher rate of impressions, clicks and conversions for ads related to electronics. Similarly, the ad targeting system 120 can map poor-performer keywords (e.g., keywords that lead to a relatively lower rate of impressions, clicks and conversions) to for a particular merchant category.

In step 408, the information is associated with a merchant based on the merchant category. For example, the ad targeting system 120 can associate with the merchant the good-performer keywords and the poor-performer keywords, based on past experience with queries within that merchant category. For example, if the merchant for which information is associated in this step 408 sells electronics, then the information that is associated with the merchant can include good-performer and poor-performer keywords related to electronics.

In step 410, a keyword submitted by a user is received. The keyword is for performing a search among articles offered by a merchant. As an example, referring to FIG. 3A, a user can enter the keyword “diamonds” in the search control 308 to search on products offered for sale by the merchant, such as on the merchant page. The ad targeting system 120, for example, can receive the keyword.

In step 412, a determination is made, using information associated with the merchant, whether the merchant offers a first article for sale that corresponds to the keyword. For example, the ad targeting system 120 can use the keyword (e.g., “diamonds”) to access or infer the set of articles that the merchant sells. In some implementations, the list of articles that are sold by a merchant can be maintained by the ad management system 110. For example, merchants who partner with the ad management system 110 can provide article availability information to the ad management system 110. In some implementations, the merchant can also provide, for each article, a set of keywords that the merchant wants to have associated with the article. In some implementations, the ad management system 110 can use the merchant-supplied keywords in selecting eligible ads.

In some implementations, the availability of the article corresponding to the keyword is indicated by its presence or absence from either list. For example, if the keyword is listed on the good-performer keywords list this can be an indication that the merchant does not carry the item, because customers have chosen to visit a different merchant based on the ad. In contrast, if the keyword is listed on the poor-performer keywords list this can be an indication that the merchant does carry the item, because the ads relatively seldom cause customers to visit a different merchant.

In step 414, broadening terms are identified for the keyword. As an example, the ad targeting system 120 can use the associations between the poor-performer and good-performer keywords lists that are determined in step 404. For example, if the keyword is “diamonds” (e.g., a good-performer keyword), then the ad targeting system 120 can select as a broadening term one or more keywords from associated poor-performer lists. The phrase “broadening term” is used here because the keywords that are selected as broadening terms are selected so as to expand the universe of matches to the terms, e.g., to identify additional eligible ads beyond those that are identified by the keyword alone.

In step 416, a selection is made regarding which of the broadening terms to use in selecting the ad. The selection of which broadening terms to use is based on whether the merchant offers the first article for sale. For example, if the merchant offers the first article for sale, then the ad targeting system 120 can select broadening terms that can be used to replace the keyword in selecting an ad. The selection of broadening terms can be based on associations between the poor-performer and good-performer keywords lists that were determined in step 404. For example, if “diamonds” is a good-performer keyword, then the ad targeting system 120 can inject associated poor-performer keywords into the query, creating an expanded query that is used to select the ad.

In some implementations, on an ongoing basis, the expanded queries and resulting ads can be logged, and the information can be fed back into the process, such as to further refine the lists of good-performer keywords and poor-performer keywords. For example, impressions, clicks and conversions that result from the expanded query can provide a measure of the query's effectiveness.

In step 418, a determination can be made whether the merchant offers the first article. In some implementations, the determination is made by the ad targeting system 120 using merchant information. In other implementations, the step 418 instead determines on which of the lists the received keyword appears.

In step 420, the ad is selected without using the keyword. For example, referring to FIG. 3A, the ad targeting system 120 can determine that the merchant whose diamond merchant web site is shown in the user interface 300 offers diamonds and diamond-related products for sale. Instead, the ad that the ad targeting system 120 selects can be based on broadening terms, such as the broadening terms that are determined in step 414. The handbag ad 306 is an example ad that the ad targeting system 120 can select in this case.

In step 422, the ad is selected using at least the keyword. The diamond necklace ad 326 is an example ad that the ad targeting system 120 can select in this case.

In step 424, at least one ad is forwarded in response to the keyword. In some implementations, the ad 306 or 326 can be provided, for example, to the browser that runs on the user's client device 106.

In some implementations, some of the steps 401-424 of the process 400 can be performed in a different order. For example, steps 401-404 can be performed after steps 406-408. In some implementations, steps 401-408 can occur on an ongoing basis, for example, as preparation for receiving the keyword in step 410. As indicated above, some of the steps can be optional. In some implementations, other steps not shown in FIG. 4 can be included in the process 400.

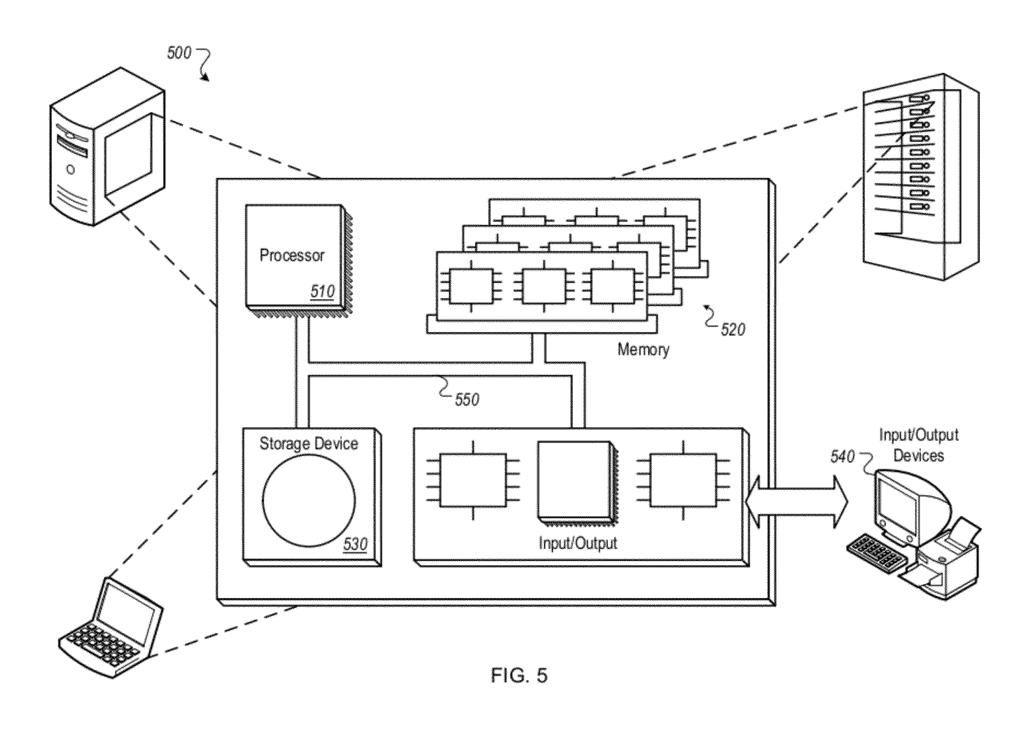

FIG. 5 is a schematic diagram of a generic computer system 500. The system 500 can be used for the operations described in association with any of the computer-implement methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. The memory 520 is a volatile memory unit in some implementations and is a non-volatile memory unit in other implementations.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer-implemented method for serving advertisements based on article availability, the method comprising:
receiving a first keyword submitted by a user for performing a search among articles offered by a merchant;
determining, using information associated with the merchant, whether the merchant offers a first article for sale that corresponds to the first keyword; and
forwarding at least one advertisement in response to the first keyword, the advertisement selected without using the first keyword if the merchant offers the first article, and selected using at least the first keyword otherwise.

2. The computer-implemented method of claim 1, wherein the information is at least in part based on advertisement data regarding earlier advertisement servings for the merchant.

3. The computer-implemented method of claim 2, wherein the information includes a poor-performer keywords list and a good-performer keywords list, wherein the first keyword is used in selecting the advertisement if the first keyword does not appear on the poor-performer keywords list, and wherein if the first keyword does appear on the poor-performer keywords list, the advertisement is instead selected using at least one second keyword from the good-performer keywords list associated with the first keyword.

4. The computer-implemented method of claim 3, further comprising:
assigning respective annotations to the keywords on the poor-performer and good-performer keywords lists; and
generating associations between the poor-performer and good-performer keywords lists by matching the respective annotations to each other.

5. The computer-implemented method of claim 1, wherein the information is at least in part provided by the merchant.

6. The computer-implemented method of claim 1, further comprising:
generating the information with regard to a merchant category; and
associating the information with the merchant based on the merchant category.

7. The computer-implemented method of claim 1, further comprising:
identifying broadening terms for the first keyword; and
selecting which of the broadening terms to use in selecting the advertisement, the selection based on whether the merchant offers the first article for sale.

8. A computer program product tangibly embodied in a computer-readable storage medium and comprising instructions that when executed by a processor perform a method for serving advertisements based on article availability, the method comprising:
receiving a first keyword submitted by a user for performing a search among articles offered by a merchant;
determining, using information associated with the merchant, whether the merchant offers a first article for sale that corresponds to the first keyword; and
forwarding at least one advertisement in response to the first keyword, the advertisement selected without using the first keyword if the merchant offers the first article, and selected using at least the first keyword otherwise.

9. The computer program product of claim 8, wherein the information is at least in part based on advertisement data regarding earlier advertisement servings for the merchant.

10. The computer program product of claim 9 wherein the information includes a poor-performer keywords list and a good-performer keywords list, wherein the first keyword is used in selecting the advertisement if the first keyword does not appear on the poor-performer keywords list, and wherein if the first keyword does appear on the poor-performer keywords list, the advertisement is instead selected using at least one second keyword from the good-performer keywords list associated with the first keyword.

11. The computer program product of claim 10, further comprising:
assigning respective annotations to the keywords on the poor-performer and good-performer keywords lists; and
generating associations between the poor-performer and good-performer keywords lists by matching the respective annotations to each other.

12. The computer program product of claim 8, wherein the information is at least in part provided by the merchant.

13. The computer program product of claim 8, further comprising:
generating the information with regard to a merchant category; and
associating the information with the merchant based on the merchant category.

14. The computer program product of claim 8, further comprising:
identifying broadening terms for the first keyword; and
selecting which of the broadening terms to use in selecting the advertisement, the selection based on whether the merchant offers the first article for sale.

15. A system comprising:
a processor; and
a computer-readable storage medium having stored therein instructions that when executed by the processor perform a method comprising:
receiving a first keyword submitted by a user for performing a search among articles offered by a merchant;
determining, using information associated with the merchant, whether the merchant offers a first article for sale that corresponds to the first keyword; and
forwarding at least one advertisement in response to the first keyword, the advertisement selected without using the first keyword if the merchant offers the first article, and selected using at least the first keyword otherwise.

16. The system of claim 15, wherein the information is at least in part based on advertisement data regarding earlier advertisement servings for the merchant.

17. The system of claim 16, wherein the information includes a poor-performer keywords list and a good-performer keywords list, wherein the first keyword is used in selecting the advertisement if the first keyword does not appear on the poor-performer keywords list, and wherein if the first keyword does appear on the poor-performer keywords list, the advertisement is instead selected using at least one second keyword from the good-performer keywords list associated with the first keyword.

18. The system of claim 17, the method further comprising:
assigning respective annotations to the keywords on the poor-performer and good-performer keywords lists; and
generating associations between the poor-performer and good-performer keywords lists by matching the respective annotations to each other.

19. The system of claim 15, wherein the information is at least in part provided by the merchant.

20. The system of claim 15, the method further comprising:
generating the information with regard to a merchant category; and
associating the information with the merchant based on the merchant category.

21. The system of claim 15, the method further comprising:
identifying broadening terms for the first keyword; and
selecting which of the broadening terms to use in selecting the advertisement, the selection based on whether the merchant offers the first article for sale.
